(19) United States
(12) Patent Application Publication
(10) Pub. No.: US 2004/0195043 A1
(43) Pub. Date: Oct. 7, 2004

(54) Collapsible ladder

(76) Inventor: Kjell Johansson, Forserum (SE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/480,698

(22) PCT Filed: Jun. 12, 2002
(86) PCT No.: PCT/SE02/01142

(30) Foreign Application Priority Data
Jun. 13, 2001 (SE) 0102109-6

(51) Int. Cl. E06C 1/00

(52) U.S. Cl. 182/195

(57) ABSTRACT

The invention relates to a collapsible ladder (1) having hollow ladder bars (2, 3) and ladder pins (4). The bars are divided into sections, which are telescopically inserted into each other and which in pairs at their top are connected to each other via a ladder pin, ladder sections, positioned above each other, being formed. The ends of the ladder pins (4) each houses its retaining mechanism (6), which via a locking pin (8) is locked against the lower portion of a ladder section, positioned above, in a separated or in a activated position of two such sections, arranged after each other, and which is releasable in order to allow an insertion of said ladder section, positioned above. According to the invention said retaining mechanisms can be actuated outside the space between the ladder pins (4), preferably on the front of the ladder, and are designed to be released in each section manually and individually, Also, the locking pins (8) project in their locking positions into the hollow space (9) in the locked bar section in order to in this area constitute safety units, designed to prevent the bar portions from passing by to the bar section, which follows after said bar section, positioned above.

The present invention relates to a collapsible ladder of the type set forth in more detail in the preamble of claim 1.

Such ladders having collapsible and expandable bar sections are used in order to be able to store them in and transport them into a very limited space.

Such a ladder is described in EP-A-0 527 766. The bars are divided into sections in pairs, ladder pins being positioned between them, and their diameter is reduced upwards, whereas the diameter increases downwards. This known ladder is characterized in that the retaining mechanisms in each ladder pin are designed to release the post sections, connected to the next higher ladder pin, when the ladder pin has been lowered towards the next ladder pin, positioned below. This means, that subsequent to the release of the first releasable ladder pin the following ladder pins are released automatically and that the ladder collapses, why accidents, particularly injuries caused by crushing, may occur. This known mechanism allows or actually invites people to manipulate it, which may lead to said disastrous results. Also, if manipulations do not occur, material wear and tear, inappropriate friction etc. may bring about similar risks and consequences respectively. Also, it is not possible, at least not without risks, to adjust the length of the ladder somewhere in the middle of the ladder. Also, an expansion of the ladder to only a portion of the maximally possible length may involve risks.

DE-73 768 relates to a locking device for hydraulically expandable fire ladders (A) with telescopic bars. In the ends of the ladder pins (N) inactive bolts (c) are mounted in a normal position, which can be prestressed by compression springs, which in their turn can be activated by clinchers (b), the bolts penetrating diametrical holes in the lower part of the bar sections. In the area, where the bolts have been drawn into a matching ladder pin (ladder pins), there are no barriers designed to prevent a total collapse of the entire ladder, the ladder pins hitting each other, why injuries caused by crushing etc. may occur.

U.S. Pat. No. 2,194,856 relates to a ladder with telescopic sections, similar to the sections in said German specification, but it is provided with spring-loaded bolts (10), which work automatically in the locking direction. This construction also has the above-mentioned drawbacks.

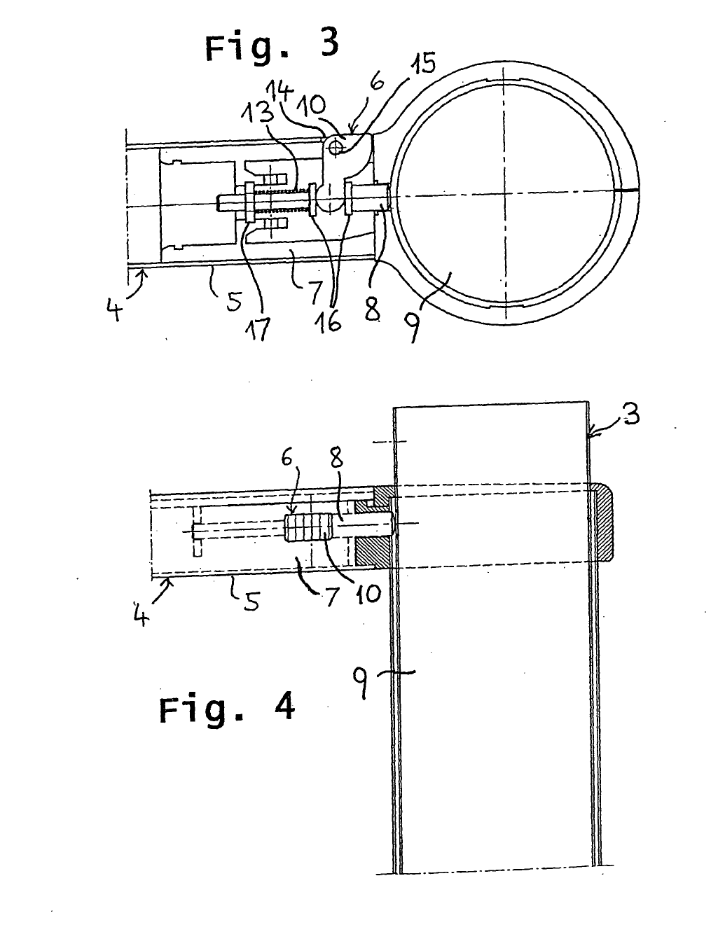

U.S. Pat. No. 4,989,692 also relates to a ladder with telescopic sections (10), the ladder pins (13) being provided with press buttons (31), designed to, via a wire, simultaneously release locking mechanisms in the two ends of the respective ladder pin. Just one strike against the only press button in each ladder pin may put the locking device out of order. The involved sections according to FIG. 3 will then collapse and the above-mentioned risks will occur.

In all the already known cases the length of the ladder always corresponds to the number of expanded ladder sections, because a ladder length between two expanded ladder sections is not possible.

The object of the present invention is to counteract and eliminate as far as possible the above-mentioned drawbacks and risks. Also, the invention will create an extra safety measure particularly against injuries caused by crushing, and consequently not even the released ladder pins will simply be pressed against each other, resulting in, that a hand or a foot might be squeezed. Also, it is desirable to be able to establish new ladder pin levels, positioned between the levels for adjacent locked bar sections, and respectively to change the length of the ladder in addition to what is possible by means of the ordinary locking of the expanded ladder sections.

These objects are attained according to the invention by mainly designing a ladder of the type described in the introduction in such a way, that is set forth in the characterizing clause of claim 1.

Additional characterizing features and advantages of the invention are described in the following text, reference being made to the accompanying drawings, which show a few preferred but not limiting embodiments of the invention. The drawings show in detail and partly schematically in:

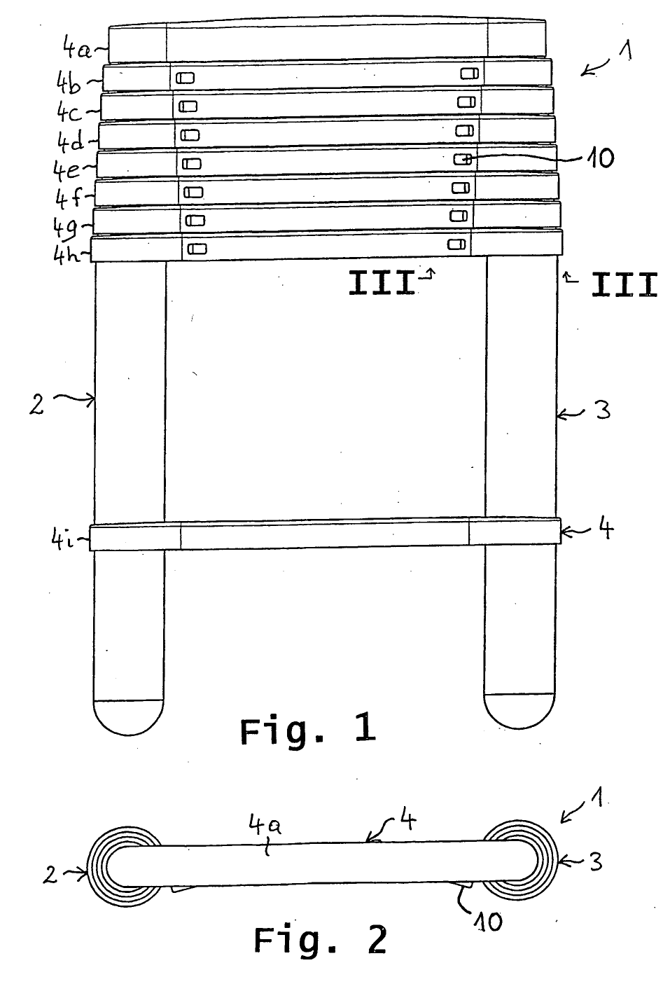

FIG. 1 a lateral view from the front of a maximally collapsed ladder according to the invention;

FIG. 2 a view from above in FIG. 1;

FIG. 3 a view along line III-I in FIG. 1, but without any bar sections, in which a locking pin, which is situated in the shown ladder pin in an actuated retaining mechanism, occupies an inactive position;

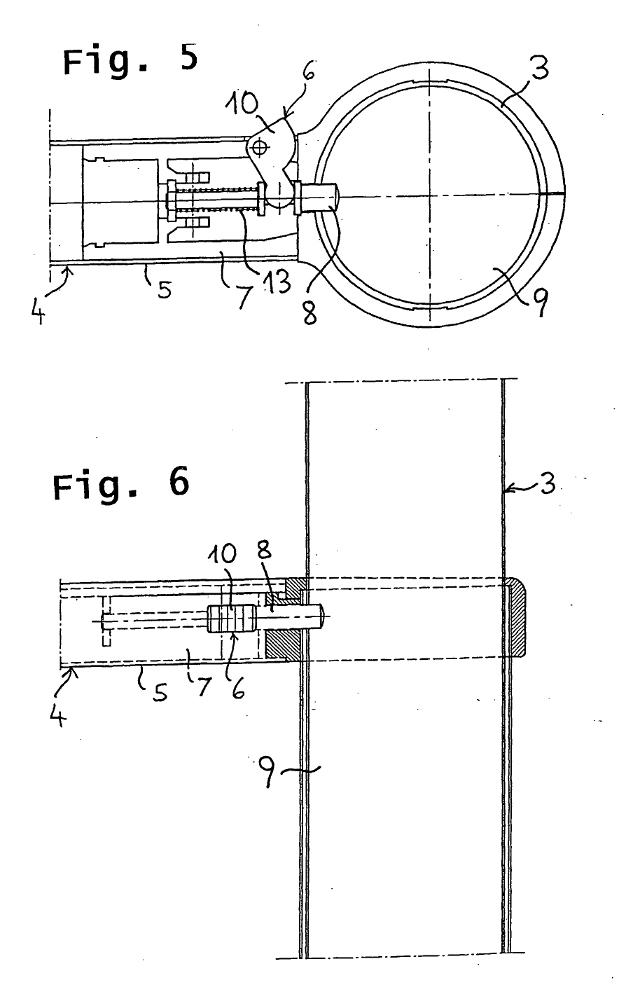

FIG. 4 a view from above in FIG. 3, showing inserted bar sections;

FIG. 5 a view, which corresponds to FIG. 3 and shows the locking position of the locking pin for an adjacent bar section;

FIG. 6 a view, which corresponds to FIG. 4, an adjacent bar section being locked;

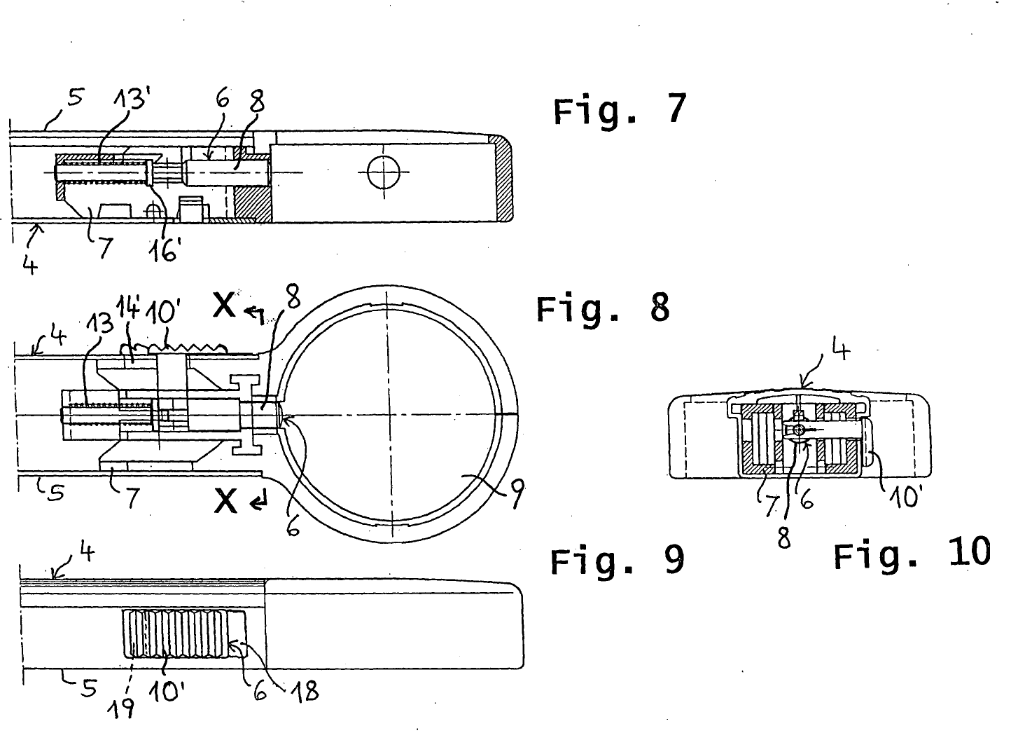

FIG. 7-10 a diametrical longitudinal section, a schematic view from below, a lateral view, and a cross-section along line X-X in FIG. 8 of an alternative retaining mechanism with slide buttons rather than rotary buttons as control units;

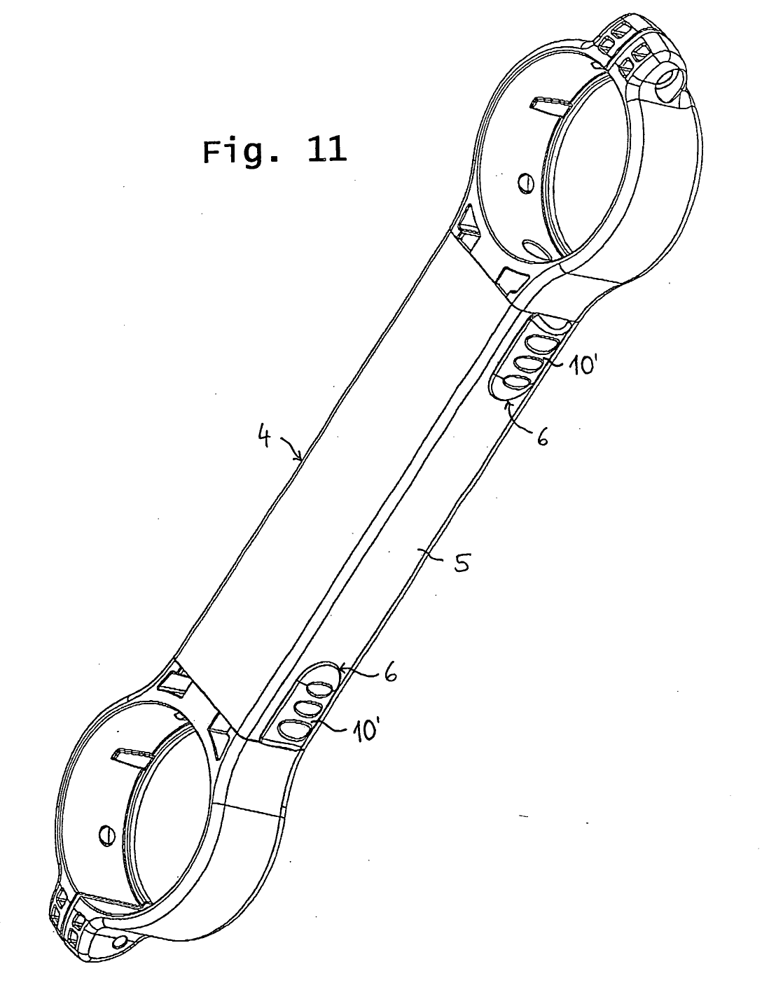

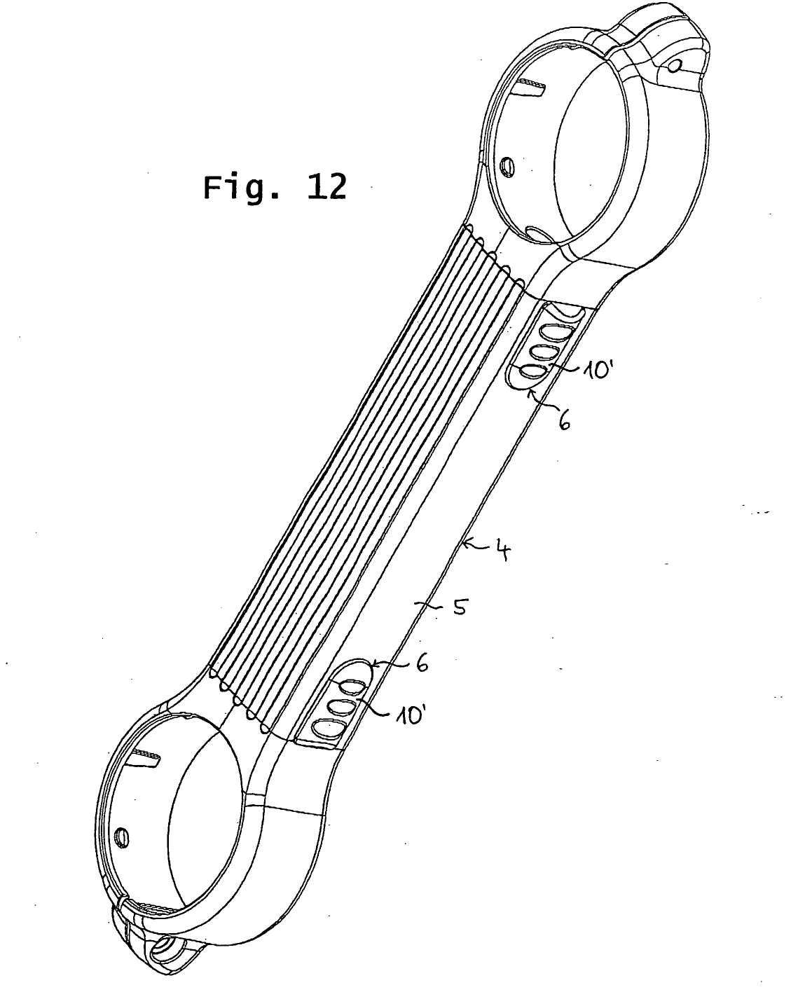

FIGS. 11 and 12 perspective views of a ladder pin with slide buttons roughly according to FIGS. 7-10 from below and above respectively; and

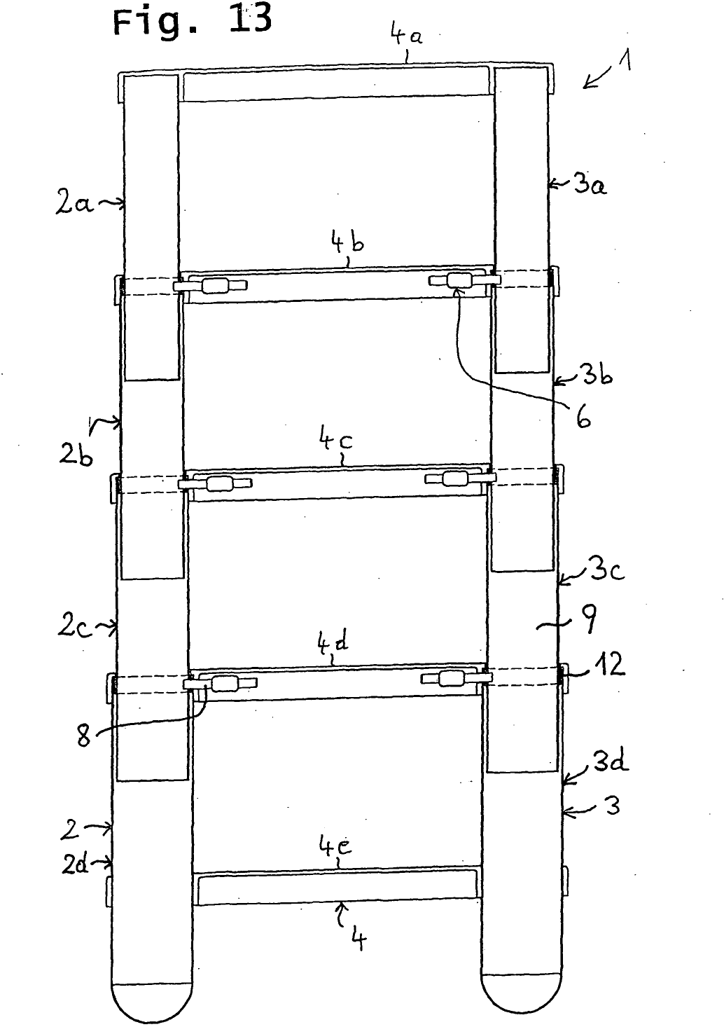

FIGS. 13-17 a ladder according to the invention in consecutive positions from a completely expanded to a completely collapsed position with an intermediate ladder section released in order to take an intermediate or security position.

In the drawings a collapsible ladder 1 according to the invention is shown in its entirety. Also, ladder bars 2 and 3 and ladder pins 4 and 4a-i respectively in their entireties are shown, the ladder pins being arranged between the ladder bars and joining them to each other. The various sections, into which the bars are divided, and which telescope into each other, are designated 2a-d and 3a-d respectively. The bar sections to the right and to the left form in pairs and jointly with the ladder pins, which are connected at the top, ladder sections. Also, the lowermost ladder section suitably is provided at the bottom with a stationary ladder pin 4i, designed to provide an extra foot support and a more stable lowermost ladder section.

Every ladder pin, which suitably is made of an extruded aluminium profile 5, houses in each one of its ends a retaining mechanism 6, which includes a shell 7, filled with said profile, e.g. by means of a press fit. The ladder pin of the uppermost ladder section may be without retaining mechanisms.

In FIGS. 1-6 retaining mechanisms 6 are shown having rotary buttons 10, used as control units, whereas the remaining drawings show retaining mechanisms 6 having slide buttons 10′, used as control units.

In retaining mechanism 6 according to FIGS. 3-6 rotary button 10, which projects from a recess 14 in the face of ladder pin 4, is rotatably mounted on a spindle 15 in shell 7, parallel to the bars. Rotary button 10 is roughly L-shaped, one of the legs in the retaining position of the mechanism projecting obliquely from said recess, whereas the other leg, e.g. a fork-shaped, rounded end, grasps the control portion of a locking pin 8 between two follower flanges 16. Locking pin 8 is displaceably mounted in the shell and is prestressed by means of a compression spring 13, which surrounds the locking pin, which spring is supported at one of its ends by means of a bearing eye 17, which is bound by the shell and receives one end of the locking pin, in order to, with the other end, abut one of follower flanges 16. The locking pin projects with its other end through a hole 11 diametrically into the respective bar section. Compression spring 13 tends to move the locking pin into and retain it in said rotating position. When the rotary button is pressed into the shell, the spring is compressed and the locking pin leaves the locking hole, which allows the respective bar section to be pushed downwards into the underlying bar section.

Slide button 10′ according to e.g. FIGS. 7-10 operates in an analogous way and the matching retaining mechanism is far-reachingly designed in an analogous way. However, recess 14′ in the front side of the ladder pin is longer in the longitudinal direction of the ladder pin, in which recess the slide button is to be moved. Also in this case one of the ends of compression spring 13′ abuts a follower flange 16′, the other side of which being designed to be actuated by the slide button.

In its position according to FIG. 13 the ladder has a maximal length and is ready to be used, said locking pins 8 being inserted into hollow space 9 of each bar section in order to safely lock each upper bar section to the underlying bar section. The safety is guaranteed, since every locking pin is constantly loaded by its spring, which tends to push the locking pin out of the ladder pin and into the hole of the adjacent upper bar section. Also, the secured position can be visually indicated by means of a field 18, which is marked out on the ladder pin and e.g. has a red colour, which becomes visible, when the locking pin is withdrawn into the ladder pin and which is superimposed by slide button 10′, when the locking pin is pushed out of the ladder pin, on the other side in the displacement direction of the control unit possibly a e.g. green field 19 being positioned on the ladder pin, which consequently will become visible, when the locking pin exerts its locking function.

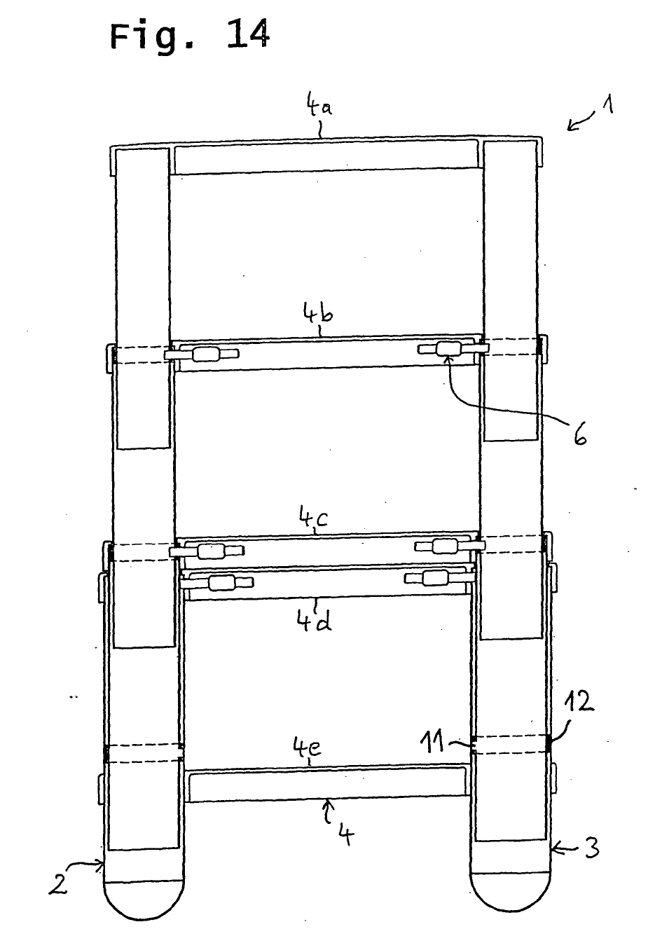

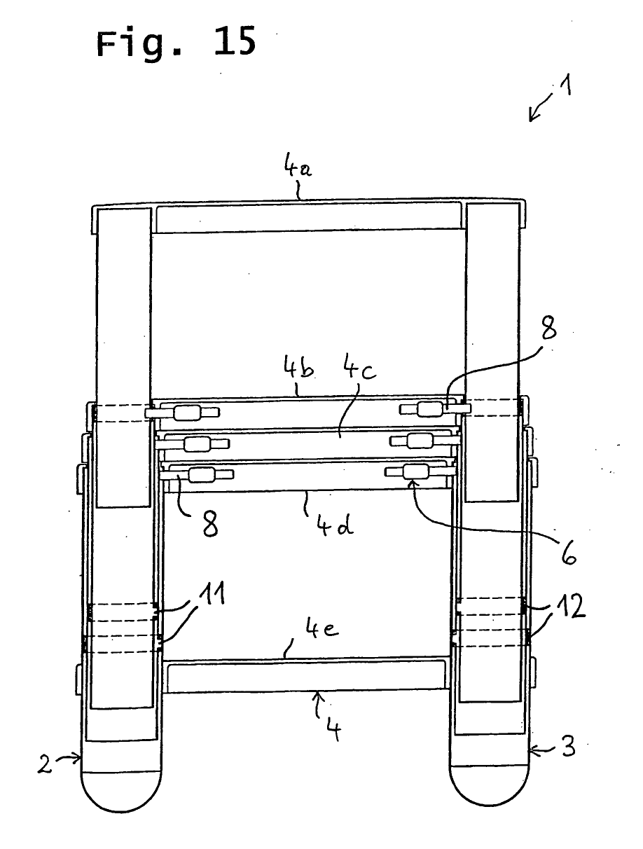

In their positions according to FIG. 14 the retaining mechanisms on the two sides in the next to lowest ladder pin have been released by moving the slide buttons towards each other, the locking pins being withdrawn from the respective locking holes in the matching bar section, which slides downwards past the locking pin ends, which thanks to the spring load are kept tightened against the outside of the respective bar section. The next to lowest bar section slides downwards, until the ladder pin from the third section from below hits the next to lowest ladder pin. No injuries caused by crushing may occur, since the user must keep both his hands around the outside of the bar section, his thumb being superimposed on said slide buttons.

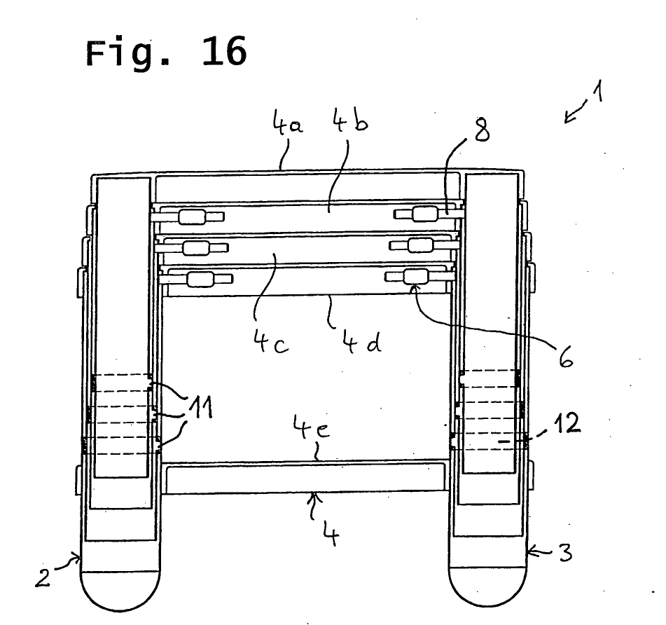

In this manner one continues section after section according to FIGS. 15 and 16, until the entire ladder has been collapsed.

When the ladder is to be expanded, one starts with the third ladder pin from below, i.e. with the second moveable ladder pin, the retaining mechanisms of which it is not necessary to move. As soon as a hole in the upwardly moved bar section ends up at the same level as the locking pin in the underlying bar section, the locking pin snaps into the hole and locks said section. One continues, until the entire ladder or a desired portion of it has been expanded.

It is shown, that there are locking holes 11 in every bar portion, into which a locking pin is designed to be inserted, and that said bar portion within the area for such a hole is surrounded by an outer safety ring 12, which is designed to prevent the par portion from being withdrawn out of the par portion, positioned below it, into which it has been inserted.

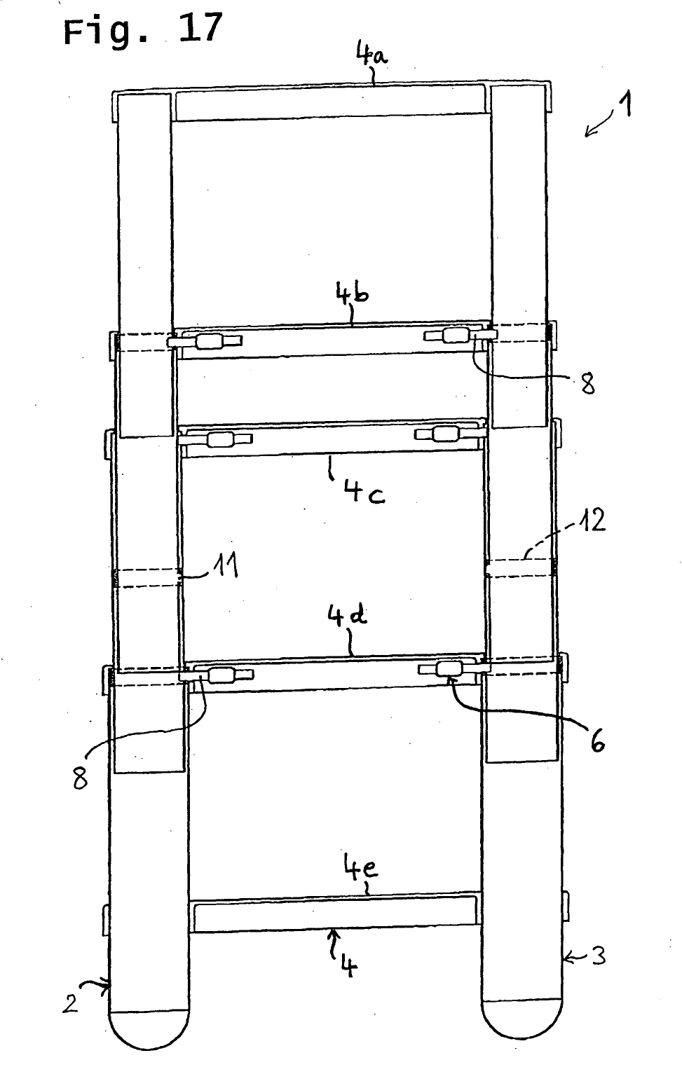

In case, e.g. by mistake, or when a certain ladder length is desired, which is situated between two bar section distances, one activates two control units somewhere in the middle of the ladder, the bar section above the retaining mechanism will sink, due to the force of gravity, but only up to the retaining mechanism positioned below, the locking pins of which, which project into said hollow space 9, serving as a limitation for a pushing downwards. In this position the two respective ladder pins are positioned at a safe distance from each other, e.g. 5-15 cm, in order to safely avoid injuries caused by crushing, which might occur, in case the ladder pins could be moved into contact with each other. Such a position is shown in FIG. 17. Otherwise, the ladder can be used in all the shown positions, i.e. it is safe to climb on the ladder or load it in other ways, since each ladder pin always is secured either by itself or by means of underlying secured ladder pins.

The invention is not limited to the embodiments described above and shown in the drawings, but it can be supplemented and modified in an arbitrary manner within the scope of the inventive idea and the enclosed claims.

1-8. (CANCELED)

9. A collapsible ladder (1) including hollow ladder bars (2,3) and ladder pins (4), the bars being divided into sections, telescopically inserted into each other, which in pairs at the top are connected to each other via a ladder pin in order to obtain ladder sections (2a-d, 3a-d), positioned above each other, the ends of the ladder pins (4) each one housing its retaining mechanism (6), which via a spring-loaded locking pin (8) locks the lower part of a ladder section, positioned above, in a separated position or in an active position of two such sections, following each other, in the bar portion of the inserted section locking holes (11) being provided, designed to receive respective locking pins (8), which retaining mechanism (6) is releasable in order to allow an insertion of the ladder section, positioned above, wherein the retaining mechanisms (6) are positioned to be actuated outside the space between the ladder pins (4), preferably at the front of the ladder, and are designed to be released as sections manually and individually on both sides, that the locking pins (8) in their locking positions are inserted into the hollow space (9) of the locked bar section in order to constitute there security devices, designed to prevent, that the bar portions pass by the bar section, which follows after the bar section, positioned above, that when the two control units (10′) of a bar section are activated by mistake or when a certain ladder length is desired, which is positioned between two bar section distances, somewhere in the middle of the ladder, the released bar section above the respective control unit is designed to, due to the force of gravity, sink downwards to the control unit of the bar section, positioned below, the locking pin of which is designed to act as a limitation for the displacement downwards, in which position the two respective ladder pins are designed to be positioned at a safe distance from each other, preferably 5-15 cm, to be sure to be able to prevent injuries caused by crushing, and in that the ladder can be used(loaded) in all its positions, since every ladder pin always is arranged to be secured either in or by itself or by means of underlying ladder pins.

10. The collapsible ladder according to claim 9, wherein the uppermost and the lowermost ladder pin (4) are stationary, the lowermost stationary ladder pin being positioned at the bottom of the lowermost ladder section, which as the only section is provided with two ladder pins, namely the lower pin and an upper ladder pin.

11. The collapsible ladder according to claim 9, wherein the retaining mechanisms (6) include rotary buttons (10) or slide buttons (10′) as control units.

12. The collapsible ladder according to claim 9, wherein a retaining mechanism (6) with a rotary button (10) the rotary button, which projects from a recess (14) in the front of the ladder pin (4), is rotatably mounted on a spindle (15) in the shell (7), parallel to the bars, in that the rotary button (10) roughly is L-shaped, one of the legs in the locking position of the mechanism obliquely projecting out of the recess, whereas the other leg, e.g. with a fork-shaped, rounded edge, holds the central portion of said locking pin (8) between two follower flanges (16), in that the locking pin (8) is displaceably mounted in the shell and is prestressed by a compression spring (13), which surrounds the locking pin and is supported at one of its ends by a bearing eye (19), which is connected to the shell and receives one end of the locking pin, whereas the other end abuts one of the follower flanges (16), whereas the locking pin with its other end diametrically extends through a hole (11) and into the respective bar section, and in that the compression spring (13) tends to move the locking pin into and keep it in said locking position, whereas, when the rotary button is pressed into the shell, the spring is designed to be compressed and the locking pin to leave the hole, the respective bar section being displaceable downwards into the underlying bar section.

13. The collapsible ladder according to claim 9, wherein a retaining mechanism (6) with a slide button (10′) a recess (14′) in the front of the ladder pin is designed to displaceably in the longitudinal direction of the ladder pin receive the slide button, one end of a compression spring (13′), which surrounds the locking pin (8) being designed to contact a follower flange (16′), positioned on the locking pin and the side of which is designed to be actuated by the slide button, and in that the functional position of the retaining mechanism is designed to be indicated visually, e.g. the secured position being indicated by a field (18) with e.g. a red color, which will be visible, when the locking pin is withdrawn into the ladder pin and which is superimposed by the slide button (10′), when the locking pin projects out of the ladder pin, and in that on the other side in the displacement direction of the slide button there is a e.g. green field (19) on the ladder pin, which will be visible, when the locking pin exerts its locking function.

14. The collapsible ladder according to claim 9, wherein the locking pin position, when the locking pin is withdrawn into the respective ladder pin, is designed to be indicated by an uncovering of a field, preferably with a red color, on the ladder pin in this position, which is superimposed by the control unit (10′), when the locking pin is projecting from the ladder pin, and in that on the other side in the displacement direction of the control unit there is a preferably green field on the ladder pin, which is designed to be visible, when the locking pin exerts its locking function.

15. The collapsible ladder according to claim 9, wherein the bar sections within the area for their locking holes (11) are surrounded by an outer safety ring (12), designed to prevent, that a bar section will be drawn out of another bar section, positioned below, into which it has been inserted.
